(19) United States
(12) Patent Application Publication
(10) Pub. No.: US 2012/0220695 A1
(43) Pub. Date: Aug. 30, 2012

(54) Carbon Nanotube Reinforced Nanocomposites

(76) Inventors: Dongsheng Mao, Austin, TX (US); Zvi Yaniv, Austin, TX (US)

(21) Appl. No.: 13/413,633

(22) Filed: Mar. 6, 2012

Related U.S. Application Data
(63) Continuation-in-part of application No. 11/693,454, filed on Mar. 29, 2007, now Pat. No. 8,129,463.
(60) Provisional application No. 60/788,234, filed on Mar. 31, 2006.
(60) Provisional application No. 60/810,394, filed on Jun. 2, 2006.

(51) Int. Cl. C08K 3/04; B82Y 30/00

(52) U.S. Cl. 523/468; 106/472; 977/750; 977/752

(57) ABSTRACT

A combination of multi-walled carbon nanotubes and single-walled carbon nanotubes and/or double-walled carbon nanotubes significantly improves the mechanical properties of polymer nanocomposites. Both flexural strength and flexural modulus of the MWNTs and single-walled carbon nanotubes and/or double-walled carbon nanotubes co-reinforced epoxy nanocomposites are further improved compared with same amount of either single-walled carbon nanotubes and/or double-walled carbon nanotubes or multi-walled carbon nanotubes reinforced epoxy nanocomposites. Besides epoxy, other thermoset polymers may also work.

This application is a continuation-in-part application of U.S. patent application Ser. No. 11/693,454, issued as U.S. Pat. No. 8,129,463, which claims priority to U.S. Provisional Application Ser. Nos. 60/788,234 and 60/810,394, all of which are hereby incorporated by reference herein.

### BRIEF DESCRIPTION OF THE DRAWINGS

FIG. 1 illustrates a process for manufacturing epoxy/carbon nanotube (“CNT”) nanocomposites in accordance with embodiments of the present invention.

### DETAILED DESCRIPTION

A combination of multi-walled carbon nanotubes (“MWNTs”) (herein, MWNTs have more than two walls) and double-walled CNTs (“DWNTs”) significantly improves the mechanical properties of polymer nanocomposites. A small amount of DWNTs reinforcement (e.g., <1 wt. %) significantly improves the flexural strength of epoxy matrix nanocomposites. A same or similar amount of MWNTs reinforcement significantly improves the flexural modulus (stiffness) of epoxy matrix nanocomposites. Both flexural strength and flexural modulus of the MWNTs and DWNTs co-reinforced epoxy nanocomposites are further improved compared with same amount of either DWNTs or MWNTs reinforced epoxy nanocomposites. Besides epoxy, other thermoset polymers may also be utilized.

In this nanocomposite system, single-walled CNTs (“SWNTs”) may also work instead of DWNTs. Therefore, a combination of MWNTs and SWNTs also significantly improves the mechanical properties of polymer nanocomposites. A small amount of SWNTs reinforcement (e.g., <1 wt. %) significantly improves the flexural strength of epoxy matrix nanocomposites. A same or similar amount of MWNTs reinforcement significantly improves the flexural modulus (stiffness) of epoxy matrix nanocomposites. Both flexural strength and flexural modulus of the MWNTs and SWNTs co-reinforced epoxy nanocomposites are further improved compared with same amount of either SWNTs or MWNTs reinforced epoxy nanocomposites. Besides epoxy, other thermoset polymers may also work.

Furthermore, a combination of MWNTs and SWNTs and DWNTs also significantly improves the mechanical properties of polymer nanocomposites. A small amount of SWNTs/DWNTs reinforcement (e.g., <1 wt. %) significantly improves the flexural strength of epoxy matrix nanocomposites. A same or similar amount of MWNTs reinforcement significantly improves the flexural modulus (stiffness) of epoxy matrix nanocomposites. Both flexural strength and flexural modulus of the MWNTs and SWNTs and DWNTs co-reinforced epoxy nanocomposites are further improved compared with same amount of either SWNTs or DWNTs or MWNTs reinforced epoxy nanocomposites. Besides epoxy, other thermoset polymers may also work.

In embodiments of the present invention, an example is provided. MWNTs, SWNTs, and DWNTs are also simply referred to as CNTs herein when discussed in a more general sense.

Epoxy resin (bisphenol-A) and a hardener (dicyandiamide) was commercially obtained. The hardener was used to cure the epoxy nanocomposites. SWNTs, DWNTs, and MWNTs were commercially obtained. The CNTs may be functionalized with amino (—NH₂) functional groups. Amino-functionalized CNTs may help to improve the bonding between the CNTs and epoxy molecular chairs, which can further improve the mechanical properties of the nanocomposites. However, pristine CNTs or functionalized by other means (such as carboxylic functional groups) may also work. Although epoxy was used as an example for the experimentation, other thermosets may also work. Thermosetting polymers that may be used as described herein include, but are not limited to, epoxies, vinyl esters, unsaturated polyesters, phenolics, cyanate esters (CEs), bismaleimides (BMIs), polyimides, or any combination thereof.

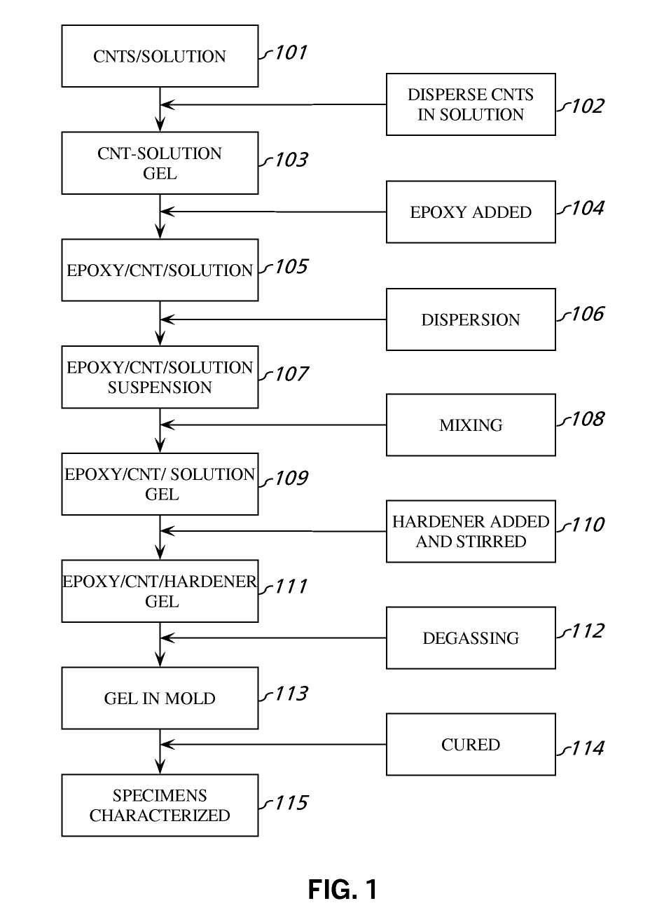

FIG. 1 illustrates a schematic diagram of a process flow to make epoxy/CNT nanocomposites. All ingredients may be dried (e.g., in a vacuum oven at approximately 70° C. for approximately 16 hours) to remove moisture. In step 101, the CNTs were placed in a solvent (e.g., acetone) and dispersed (e.g., by a micro-fluidic machine commercially available from Microfluidics Co.) in step 102. The micro-fluidic machine uses high-pressure streams that collide at ultra-high velocities in precisely defined micron-sized channels. Its combined forces of shear and impact act upon products to create uniform dispersions. The CNT solution was then formed as a gel in step 103 resulting in the CNTs well dispersed in the solution. However, other methods, such as an ultrasonication process, may also be utilized to disperse the CNTs in a solvent. A surfactant may be also used to disperse the CNTs in solution. Epoxy was then added in step 104 to the CNT/solvent gel to create an epoxy/CNT/solvent solution 105, which was followed by another mixing process 106 (e.g., ultrasonication in a bath at approximately 70° C. for approximately 1 hour) to create an epoxy/CNT/solvent suspension 107. The CNTs were further dispersed in epoxy in step 108 (e.g., using a stirrer mixing process at approximately 70° C. for approximately half an hour at a speed of approximately 1,400 rev/min. to create an epoxy/CNT/solvent gel 109. A hardener was than added in step 110 to the epoxy/CNT/solvent gel 109 (e.g., at a ratio of approximately 4.5 wt. %) followed by stirring (e.g., at approximately 70° C. for approximately 1 hour). The resulting gel 111 was degassed in step 112 (e.g., in a vacuum oven at approximately 70° C. for approximately 48 hours). The material 113 was then poured into a mold (e.g., Teflon) and cured (e.g., at approximately 160° C. for approximately 2 hours). Mechanical properties (flexural strength and flexural modulus) of the specimens were characterized in step 115 after an optional polishing process.

Table 1 shows the mechanical properties (flexural strength and flexural modulus) of the epoxies made using the process flow of FIG. 1 to make epoxy/CNT nanocomposites.

As indicated in Table 1, the flexural strength of epoxy/DWNTs is higher than that of epoxy/MWNTs at the same loading of CNTs, while the flexural modulus of epoxy/DWNTs is lower than that of epoxy/MWNTs at the same loading of CNTs. Both the flexural strength and flexural modulus of epoxy/DWNTs (0.5 wt. %)/MWNTs (0.5 wt. %) are higher than those of epoxy/DWNTs (1 wt. %).

Also as indicated in Table 1, the flexural strength of epoxy/SWNTs is higher than that of epoxy/MWNTs at the same loading of CNTs, while the flexural modulus of epoxy/SWNTs is lower than that of epoxy/MWNTs at the same loading of CNTs. Both the flexural strength and flexural modulus of epoxy/SWNTs (0.5 wt. %)/MWNTs (0.5 wt. %) are higher than those of epoxy/SWNTs (1 wt. %).

Furthermore as indicated in Table 1, the flexural strength of epoxy/SWNTs/DWNTs is higher than that of epoxy/MWNTs at the same loading of CNTs, while the flexural modulus of epoxy/SWNTs/DWNTs is lower than that of epoxy/MWNTs at the same loading of CNTs. Both the flexural strength and flexural modulus of epoxy/SWNTs (0.5 wt. %)/DWNTs (0.5 wt. %)/MWNTs (0.5 wt. %) are higher than those of epoxy/SWNTs/DWNTs (1 wt. %). Higher loadings of the CNTs may also work.

TABLE 1

| | Flexural | Flexural |
|---|---|---|
| | strength | modulus |
| Epoxy material | (MPa) | (GPa) |
| Neat epoxy | 116 | 3.18 |
| Epoxy/MWNTs (0.5 wt. %) | 130.4 | 3.69 |
| Epoxy/MWNTs (1.0 wt. %) | 137.7 | 3.90 |
| Epoxy/DWNTs (0.25 wt. %) | 128.8 | 3.24 |
| Epoxy/DWNTs (0.5 wt. %) | 138.9 | 3.26 |
| Epoxy/DWNTs (1.0 wt. %) | 143.6 | 3.43 |
| Epoxy/DWNTs (0.5 wt. %)/MWNTs (0.5 wt. %) | 154.2 | 3.78 |
| Epoxy/SWNTs (0.25 wt. %) | 131.8 | 3.22 |
| Epoxy/SWNTs (0.5 wt. %) | 154.8 | 3.25 |
| Epoxy/SWNTs (0.5 wt. %)/MWNTs (0.5 wt. %) | 168.7 | 3.83 |
| Epoxy/SWNTs (0.25 wt. %)/DWNTs (0.25 wt. %) | 147.2 | 3.25 |
| Epoxy/SWNTs (0.5 wt. %)/DWNTs (0.5 wt. %) | 173.8 | 3.40 |
| Epoxy/SWNTs (0.25 wt. %)/DWNT (0.25 wt. | 161.8 | 3.81 |
| %)/MWNT (0.5 wt. %) | | |

What is claimed:

1. A composite material comprising:
a thermoset;
single-walled carbon nanotubes; and
multi-walled carbon nanotubes, wherein a total concentration of the carbon nanotubes includes a concentration of the single-walled carbon nanotubes and a concentration of the multi-walled carbon nanotubes selected such that the composite material has a flexural strength and a flexural modulus that exceed the flexural strength and the flexural modulus, respectively, of a composite material comprising the thermoset and substantially a same total concentration of either single-walled carbon nanotubes or multi-walled carbon nanotubes.

2. The material as recited in claim 1, wherein the concentrations of the single-walled carbon nanotubes and the multi-walled carbon nanotubes are optimal for increasing both the flexural strength and the flexural modulus of the composite material.

3. The material as recited in claim 2, wherein the concentration of the single-walled carbon nanotubes is between 0.01-40 wt. %.

4. The material as recited in claim 2, wherein the concentration of the single-walled carbon nanotubes is between 0.01-20 wt. %.

5. A composite comprising a content of thermoset of 60-99.98 wt. %, a content of multi-walled carbon nanotubes of 0.01-20 wt. %, and a content of single-walled carbon nanotubes of 0.01-20 wt. %.

6. The composite of claim 5, wherein the thermoset comprises an epoxy.

7. A method for making a carbon nanotube composite by varying an amount of carbon nanotubes to be added to the composite as a function of the diameters of the carbon nanotubes to increase the flexural strength and the flexural modulus of the carbon nanotube composite.

8. The method as recited in claim 7, wherein the carbon nanotubes are single-walled carbon nanotubes.

9. The method as recited in claim 7, wherein the carbon nanotubes are multi-walled carbon nanotubes.

10. The method as recited in claim 7, wherein a ratio of single-walled carbon nanotubes to multi-walled carbon nanotubes within the composite is varied to increase the flexural strength and the flexural modulus of the carbon nanotube composite.

11. The method as recited in claim 10, wherein the composite further comprises a thermoset.

12. The method as recited in claim 10, wherein the composite further comprises an epoxy.

13. A composite material comprising:
a thermoset;
single-walled carbon nanotubes
double-walled carbon nanotubes; and
multi-walled carbon nanotubes, wherein a total concentration of the carbon nanotubes includes a concentration of the single-walled carbon nanotubes, a concentration of the double-walled carbon nanotubes, and a concentration of the multi-walled carbon nanotubes selected such that the composite material has a flexural strength and a flexural modulus that exceed the flexural strength and the flexural modulus, respectively, of a composite material comprising the thermoset and substantially a same total concentration of either single-walled carbon nanotubes, double-walled carbon nanotubes, or multi-walled carbon nanotubes.

14. The material as recited in claim 13, wherein the concentrations of the single-walled carbon nanotubes, the double-walled carbon nanotubes, and the multi-walled carbon nanotubes are optimal for increasing both the flexural strength and the flexural modulus of the composite material.

15. The material as recited in claim 14, wherein the concentration of the single-walled carbon nanotubes or the double-walled carbon nanotubes is between 0.01-40 wt. %.

16. The material as recited in claim 15, wherein the concentration of the single-walled carbon nanotubes or the double-walled carbon nanotubes is between 0.01-20 wt. %.

17. A composite comprising a content of thermoset of 60-99.98 wt. %, a content of multi-walled carbon nanotubes of 0.01-20 wt. %, a content of double-walled carbon nanotubes of 0.01-20 wt. %, and a content of single-walled carbon nanotubes of 0.01-20 wt. %.

18. The composite of claim 17, wherein the thermoset comprises an epoxy.

19. A method for making a carbon nanotube composite by varying an amount of carbon nanotubes to be added to the composite as a function of the diameters of the carbon nanotubes to increase the flexural strength and the flexural modulus of the carbon nanotube composite, wherein the carbon nanotubes comprise single-walled carbon nanotubes, double-walled carbon nanotubes, and multi-walled carbon nanotubes.

20. The method as recited in claim 19, wherein a ratio of single-walled carbon nanotubes to multi-walled carbon nanotubes within the composite is varied to increase the flexural strength and the flexural modulus of the carbon nanotube composite.

21. The method as recited in claim 20, wherein a ratio of double-walled carbon nanotubes to multi-walled carbon nanotubes within the composite is varied to increase the flexural strength and the flexural modulus of the carbon nanotube composite.

22. The method as recited in claim 21, wherein a ratio of double-walled carbon nanotubes to multi-walled carbon nanotubes within the composite is varied to increase the flexural strength and the flexural modulus of the carbon nanotube composite.

23. The method as recited in claim 19, wherein a ratio of single-walled carbon nanotubes to double-walled carbon nanotubes within the composite is varied to increase the flexural strength and the flexural modulus of the carbon nanotube composite.

24. The method as recited in claim 19, wherein the composite further comprises a thermoset.

25. The method as recited in claim 19, wherein the composite further comprises an epoxy.
